(19) United States
(12) Patent Application Publication
(10) Pub. No.: US 2013/0063339 A1
(43) Pub. Date: Mar. 14, 2013

(54) APPARATUS FOR SELECTING MULTIMEDIA INFORMATION

(71) Applicant: Ferdinand Maier, Neumarkt am Wallersee (AT)

(72) Inventor: Ferdinand Maier, Neumarkt am Wallersee (AT)

(73) Assignee: FM MARKETING GMBH, Neumarkt am Wallersee (AT)

(21) Appl. No.: 13/599,510

(22) Filed: Aug. 30, 2012

(30) Foreign Application Priority Data
Sep. 8, 2011 (EP) 11 007 298.0

(51) Int. Cl. G09G 5/00

(52) U.S. Cl. 345/156

(57) ABSTRACT

An apparatus for selecting multimedia information containing an operating unit that comprises an actuation device that is movable back and forth into and out of a neutral position causing an output signal depending on the shift position of the actuation device, which causes movement of display unit elements in a scrolling manner where the elements are represented one after the other on a display unit in such a manner that the respective forward element covers the subsequent elements only partially, and the respective rearward elements are smaller than the respective forward elements.

### FIELD OF THE INVENTION

The invention pertains to an apparatus for selecting multimedia information.

### REFERENCE TO RELATED APPLICATIONS

This application claims priority to European application 11 007 298.0 filed Sep. 8, 2011, the entire disclosure of which is expressly incorporated by reference.

### BACKGROUND

Such an apparatus is known from DE 602 21 876 T2. There, a program guide data selection device for selecting program guide data corresponding to available program content is described, comprising the following: a remote control with several operating keys, a control unit that receives signals from the remote control, and a television monitor. The control unit here can be a set top box that receives via various data sources, for example, satellite television, cable television, terrestrial television or internet, data that also contain program content data as transmitted, for example, by multiple television transmitters under the term “EPG” (Electronic Program Guide). These program content data are given to a content data control circuit that configures the data for display on the television monitor. The data are displayed on the television monitor in the form of an image scroll bar extending vertically and of an image scroll bar extending horizontally, wherein these two image scroll bars intersect in a focus area. The program content data represented in the focus area can be selected via the remote control, and the associated television program can be displayed. To move the program content data contained in the image scroll bars, the remote control has four individual keys for the movements “up,” “down,” “left,” and “right.” At the time of each actuation of the corresponding key, all the elements of the vertical or of the horizontal image scroll bar are shifted by a predetermined position in the selected direction. As a result, a so-called scrolling or shifting of the individual element occurs. If the user wishes to select in the corresponding image scroll bar a program that is relatively far from the focus field, then he must actuate the corresponding key several times, which takes some time and is inconvenient.

Similar apparatuses for selecting multimedia information are also known from WO 2004/055717 A and US 2003/001907 A1. The following documents describe the use of horizontal and vertical image scroll bars: WO 03/043318 A1, U.S. Pat. No. 6,690,391 B1 and EP 2001223 A1.

All these known devices have the above-mentioned disadvantage that a multiple actuation of the corresponding control keys is required. Moreover, the representation of a plurality of elements on a flat surface leads to a confusing representation.

### SUMMARY OF THE INVENTION

The problem of the invention therefore is to improve the apparatus for selecting multimedia information to the effect that its operation is simplified.

Briefly, therefore, the invention is directed to an apparatus for selecting multimedia information comprising an operating unit that comprises an actuation device and transmits signals to a receiver unit, a display device connected to the receiver unit, on which display device several elements are represented simultaneously, which represent selectable multimedia information, wherein the actuation device of the operating unit is shiftable in at least one direction out of a neutral position to a shift position, and back to the neutral position, the operating unit produces an output signal depending on the shift position of the shiftable actuation device, the elements on the display device are represented one after the other, in such a manner that a respective front-most element only partially covers subsequent elements, and respective rearward elements are smaller than respective forward elements, the receiver unit changes the represented elements depending on the output signal of the operating unit depending on the shift position of the actuation device in such a manner that the respective front-most element is replaced by another element, and all additional displayed elements change their size in accordance with their rank order, and the speed of the change of the elements depends on the shift position of the shiftable actuation device.

Advantageous embodiments and variants of the invention can be obtained from the dependent claims.

The basic idea of the invention consists in carrying out the “scrolling” of the selectable multimedia information by means of an actuation device contained in the operating unit, for example, a remote control, which actuation device can be shifted back and forth in a straight line in at least one direction. Depending on the shifting of this actuation device out of a neutral position, the “scrolling” occurs more rapidly or more slowly. The selectable multimedia information is represented like index cards, in such a manner that the respective forward element in each case covers the subsequent elements only partially, and the respective rearward elements are smaller than the respective forward elements. Depending on the direction of movement of the shiftable actuation device, the respective front-most element is replaced by another element, and all the displayed elements change their size in accordance with their rank order or sequential arrangement. As a result, the visual impression generated is that of a movement of the elements in depth, that is, into the television set or out of the television set, and thus a 3-D effect is achieved. If the shiftable actuation device is brought into its neutral position, the movement continues automatically to the next element, and then it is stopped.

According to a variant of the invention, the shiftable actuation device is kept in a neutral position by a spring or magnet force. To be able to move it out of the neutral position, a haptically perceptible force is therefore required, which increases with the distance from the neutral position. The user as a result receives a haptically perceptible return message, and via the representation of the monitor, also a visually perceptible return message concerning the speed of the “paging through” the individual elements. Both the haptically and also the visually perceptible return message are perceived by the user as analog parameters. The shifting of the shiftable actuation device thus also generates an analog or a quasi-analog signal that can also be digitized optionally in a finer grading that is not perceptible by the user.

In general, the apparatus according to the invention, due to the shiftable actuation device, has only one main navigation direction that visually generates a three-dimensional effect, in particular out of or into the plane of the monitor. In contrast, the known prior art has two navigation directions in the monitor plane.

In the case of selection menus having several menu planes, the same principle is used. For example, if an element of the first menu plane, for example, a certain television station, is selected, then actions to be selected appear again in a second menu plane in the same representation type by means of which actions such as “view program,” “record,” “preprogram,” etc., can be selected.

An additional possibility of selecting certain menus or functions is implemented according to a variant of the invention by a position or movement sensor, wherein static, semi-dynamic and dynamic positions of the remote operation can be distinguished here. In the case of a static function, the position of the remote control is sensed, and, for example, the remote control and/or the apparatus to be operated remotely is/are switched off if the remote control has assumed a certain position, for example, when it lies on a table in such a manner that the actuation device points downward.

In the case of a semi-dynamic function, the user holds the remote control in a normal manner in the hand. If the remote control is rotated about its longitudinal axis by 90°, then a sound level menu is called up and displayed, and the sound level can be adjusted with the shiftable operating device.

In the case of a dynamic function, movement in the six possible degrees of freedom is detected, i.e., linear movement along the three orthogonal spatial axes x, y and z, and rotation about one of the three possible rotation axes, whereby predetermined functions or menus can be selected.

### BRIEF DESCRIPTION OF THE FIGURES

The invention is explained in further detail below using embodiment examples in reference to the drawing.

FIG. 1 shows a diagrammatic representation of the apparatus for selecting multimedia information according to the invention;

FIGS. 2-4 show representations of elements on a display device with three successive representations;

FIG. 5 shows a representation of elements on the display device using a submenu,

FIG. 6 shows a representation of elements similar to FIG. 1 in an additional embodiment example of the invention.

### DETAILED DESCRIPTION OF PREFERRED EMBODIMENTS

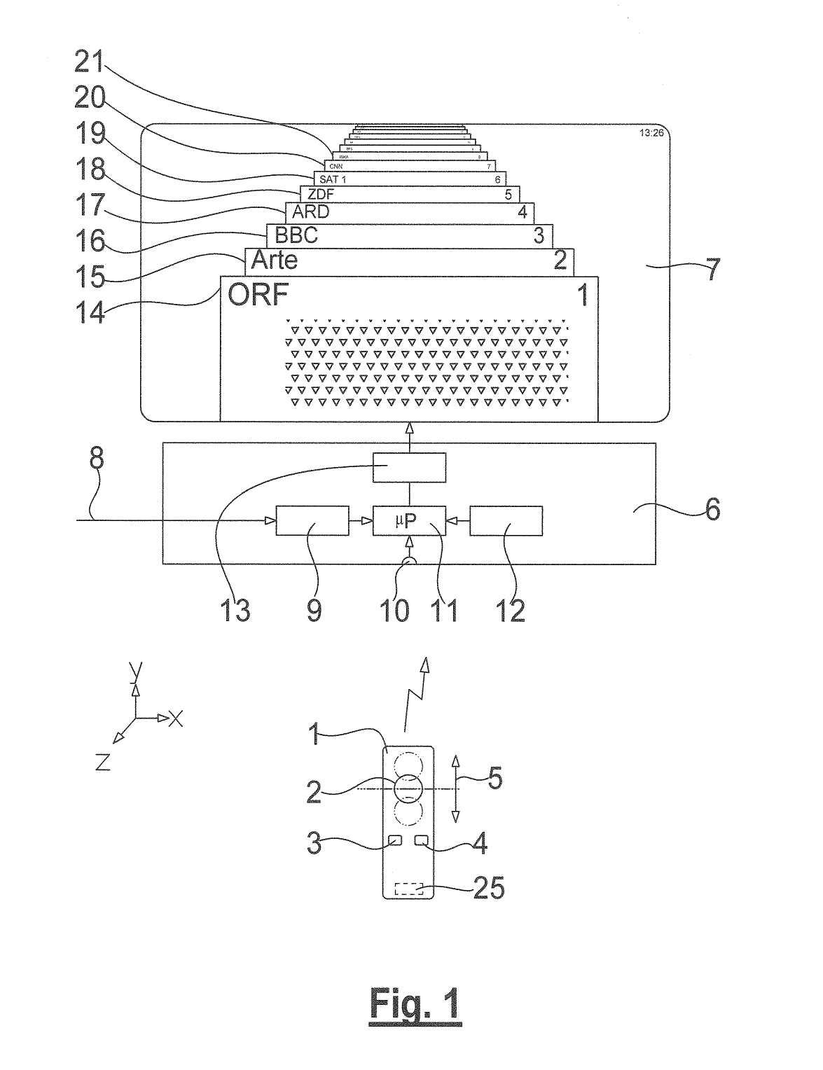

The apparatus of FIG. 1 shows as operating unit a remote control 1, which has an actuation device 2 that can be shifted back and forth in a straight line, i.e., in one direction and back in the opposite direction as shown at 5; as well as several operating keys 3 and 4. The actuation device 2 can be a shiftable key that is shiftable out of a neutral position in a straight line in the direction of the double arrow 5, which is illustrated by positions represented with broken lines. The actuation device 2 is preferably brought into a neutral position by spring force or magnet force, from which it can be shifted only by the action of a mechanical force. If the user releases the actuation device 2, then the latter is moved automatically into the neutral position. It can be seen in FIG. 1, therefore, that the actuation device is shiftable from the neutral position to a forward shift position and back to the neutral position, and from the neutral position to a rearward shift position and back to the neutral position, and that the shifting to the forward shift position, back to the neutral position, and to the rearward shift position are on the straight line 5. In this embodiment depicted, the actuation device is shiftable only on this straight line between the forward and rearward shift positions and through the neutral position in the middle between the forward and rearward shift positions. The actuation device 2 can be a shiftable key. However, it is also possible to move the entire upper plate of the remote control 1 in a straight line in the direction of the double arrow 5. The remote control 1 generates a coded signal that represents the shift position of the actuation device 2 relative to the neutral position. This signal is transmitted to a reception portion 6, preferably wirelessly, for example, by infrared or radio signals.

However, the operating unit (1) and the actuation device (2) can also be integrated in the receiver unit (6) or the display unit (7), and the signal transmission occurs via electrical lines.

The additional keys 3 and 4 are function keys to which certain commands are assigned, which are also transmitted by the remote control 1 to the receiver unit 6. In this manner, the key 3 can be assigned a selection or actuation function (Ok function), for example, and the key 4 can be assigned the “back” function by means of which a menu plane can be moved back.

It is important that the actuation device 2 be steplessly shiftable, preferably in a straight line. Due to the mentioned spring or magnet force, the user receives a haptically perceptible return message pertaining to the shifting of the actuation device 2 out of its neutral position, which is indicated by a broken, horizontal line. The term “steplessly” here means that no steps can be perceived haptically by the user, even if the signal processing is carried out internally in discrete steps.

The receiver unit 6 is connected to a display unit 7, for example, a television monitor or another monitor. The receiver unit 6 has one or more inputs 8 for receiving signals, for example, satellite television, cable television, terrestrial television or internet, or external peripheral apparatuses, for example, DVD recorders or video recorders (VCR), or an external data carrier, for example, external hard disk, USB stick or the like. This data also contain multimedia information, for example, the title of a program, short description of its content, duration, etc., as transmitted, for example, in the case of television programs, under the term “EPG” (Electronic Program Guide). This multimedia information is temporarily stored in a data storage unit 9 and can be called up by a microprocessor 11.

To the microprocessor 11, an additional receiver device 10 is connected, which receives the signals sent by the remote control 1. Moreover, to the microprocessor 11, a program storage unit 12 is connected, which contains the program required for selecting the multimedia information. Finally, the microprocessor 11 is connected via a graphics driver circuit 13 to the display device 7.

On the display device 7, the separately selectable multimedia information is represented as elements 14-21, in particular, in general terms like “index cards” stacked one after the other. Here the front-most element 14 is completely visible, whereas all additional elements 15-21 are partially covered by the respective forward element, so that only a title bar is visible. Moreover, the respective rearward elements are smaller than the respective forward elements, so that visually a three-dimensional, perspective impression is generated.

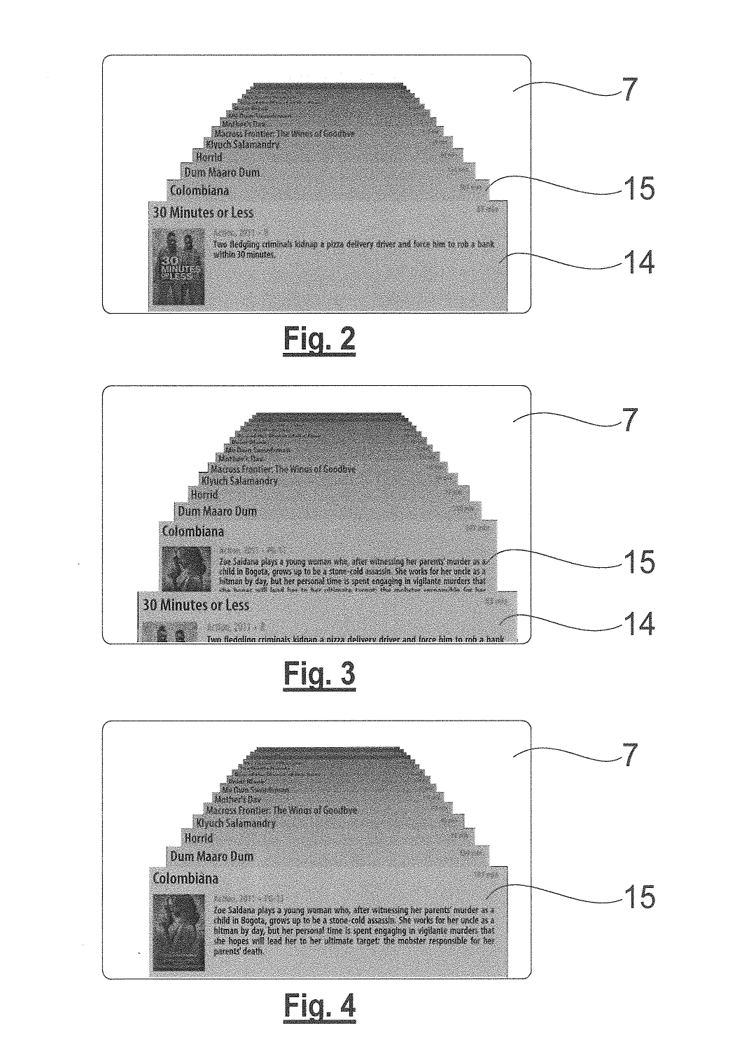

For the selection of the desired multimedia information, the user shifts the actuation device 2 on the remote control 1 in a direction marked by the double arrow 5, after which the elements 14-21 are “shifted” on the display device 7, which is explained using a concrete embodiment example in reference to FIGS. 2-4.

In FIG. 2, several elements of selectable films are represented. The front-most element 14 designates a film whose title is “30 minutes or less.” The subsequent element 15 designates a film entitled “Columbiana.” If the user shifts the actuation device 2 downward (in FIG. 1), then the first element 14 on the monitor is shifted downward, and the subsequent element 15 becomes increasingly visible, as represented in FIG. 3. When the actuation device 2 continues to be held in the shift position, the element 14 disappears completely, and the element 15 moves to the front-most position. In the process, it changes its size, so that it assumes in the representation shown in FIG. 4 the size of the element 14 of FIG. 2. All additional elements 16-21 also advance by one place in the rank order, and change their size accordingly. This “paging through” or “scrolling” is continued as long as the user holds the actuation device 2 shifted out of the neutral position.

The speed of this “scrolling” is influenced by the shift position of the actuation device 2. The farther the user moves the actuation device 2 out of the neutral position, the more rapidly the shifting of the elements occurs. Here, the acceleration of the movement of the actuation device 2 can also be evaluated and taken into consideration in the representation on the monitor 7. This shifting can occur in the two directions represented by the double arrow 5. The user can figuratively speaking page forward and backward, and this at a speed determined by him. For example, in the case of the position represented in FIG. 4, if he shifts the operating device 2 downward, then a “paging back” occurs, and the element 14 appears again in accordance with FIGS. 3 and 2.

As soon as the user releases the actuation device 2, it reaches, due to the described spring or magnet forces, the neutral position, and thereafter the display of the elements 14-21 continues to move in the previously selected movement direction until the front-most element has reached its full size.

Alternatively, it is also possible to provide that the user briefly deflects the actuation device 2 only once out of the neutral position, and then releases it again, wherein the representation of the monitor 7 continues to move without deflection of the actuation device 2 until the user interrupts the process, which can occur by renewed movement of the actuation device 2, pressing of an additional key 3 or 4, or by moving the remote control as a whole, wherein said remote control is detected by the position and/or movement sensor 24.

Depending on the quantity of selectable multimedia information that is available, new elements are displayed in the described paging through. The quantity of elements to be displayed is in principle freely selectable, and it is determined on the basis of clarity of arrangement.

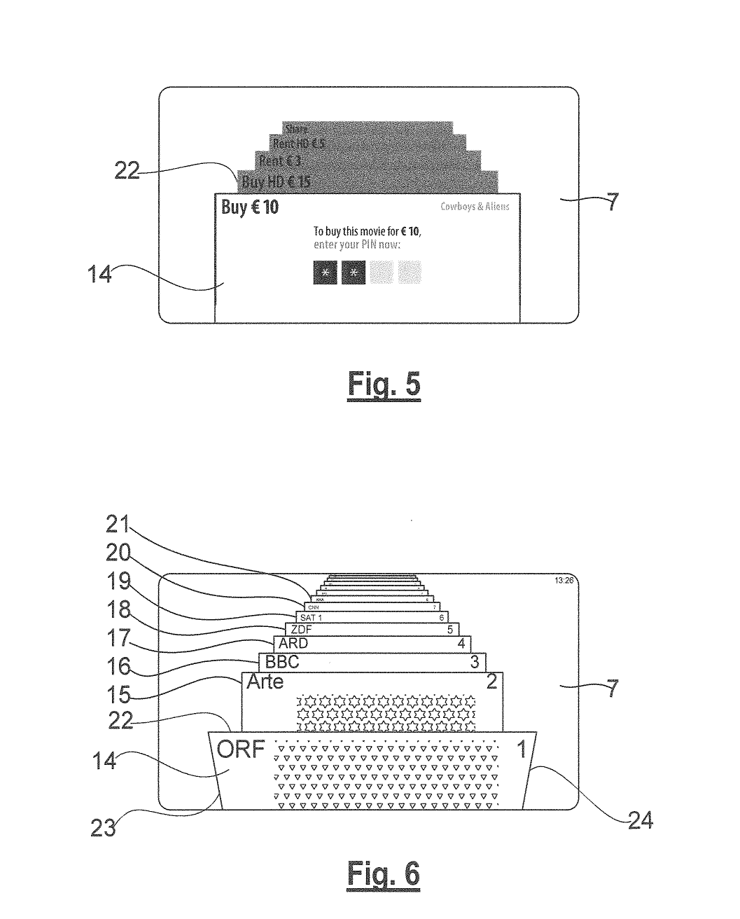

If the user has placed by means of the operating device 2 the desired multimedia information as front-most element 14 on the display unit 7, then he is able to call up a submenu shown in FIG. 5 by actuating one of the keys 3 or 4. Instead of actuation of one of the keys 3 or 4, the corresponding submenu can also be called up by moving the remote control 1 in a combined action with a position and/or movement sensor 25. In this submenu, the user can, in the example shown, select to purchase, rent, etc., a certain film using “video on demand.” The representation of the elements occurs in the same manner as for the embodiment examples of FIGS. 1-4. Here too, the “paging through” the individual elements occurs at a speed corresponding to the shifting of the actuation device 2.

FIG. 6 shows a modified variant in which the front-most element 14 is not shifted vertically downward, as represented in FIG. 3; instead it is represented like an index card that is flipped forward out of the monitor plane. In the process, the upper margin 22 of the element 14 is enlarged horizontally in the direction of the X axis, while the side margins 23 and 24 are positioned at a slant, giving the impression of a perspective representation.

As an additional variant, a representation can also be made showing that the front-most element 14 becomes more transparent, and the element 15 located behind it becomes continuously more distinct, until the front-most element 14 has completely disappeared and all the additional elements advance by one position.

The described principles are used with all possible menus, which gives the impression that the elements move along the Z axis out of or into the monitor plane (X, Y).

As additional characteristics, it is possible to provide that the remote control contain a position or movement sensor 25, and depending on the output signal of the latter, additional functions are triggered.

In these additional functions, static, semi-dynamic and dynamic functions are distinguished. In the case of a static function, the position sensor 25 generates a signal that characterizes the static position of the remote control, that is, which side of the usually six sides of the remote control points, with respect to the surface of the earth, upward, downward, to the right or to the left. With this signal, certain functions can be activated or deactivated. For example, the remote control or the apparatus to be controlled remotely can be switched on or off if a certain position is detected. Additional functions can also be implemented, for example, switching an illumination of the remote control on or off, switching the loudspeaker to mute, etc.

In the semi-dynamic function, a position sensor detects the change from one position to another position, or a motion sensor detects predetermined movements, which also results in the generation of control signals by means of which predetermined functions are triggered. For example, by such a position change or movement, a certain submenu can be called up, for example, a menu for changing the sound level, for changes of the basic setting of a television apparatus, such as, color, brightness, etc. This may also take over the “selection” and “back” functions of the described keys 3 and 4.

In the case of the dynamic function with a movement sensor, the movement is detected in the six possible degrees of freedom, and the signal generated by the movement sensor can trigger predetermined functions, for example, also a change in the sound level or the like.

In summary, the invention provides an apparatus for selecting multimedia information, wherein the actuation device for the selection needs to be moved only along a straight line, and the shifting of the actuation device determines the speed of the representation of the elements on a display device. The representation of the elements is selected such that the impression of a one-dimensional movement into or out of the monitor plane is generated, consistent with the movement direction of the actuation device. The “depth” relative to the z axis in FIG. 1 in the final result is simulated by a perspective projection on the xy plane. From the spring or magnet prestressed actuation device, the user receives a haptic return message that is in agreement with the visual return message. As a result, the operation of the apparatus is considerably simplified.

In view of the above, it will be seen that the several objects of the invention are achieved and other advantageous results attained.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above compositions and methods without departing from the scope of the invention, it is intended that all matter contained in the above description and shown in the accompanying drawings shall be interpreted as illustrative and not in a limiting sense.

1. Apparatus for selecting multimedia information comprising:
an operating unit that comprises an actuation device and transmits signals to a receiver unit,
a display device connected to the receiver unit, on which display device several elements are represented simultaneously, which represent selectable multimedia information,
wherein
the actuation device of the operating unit is shiftable in at least one direction out of a neutral position to a shift position, and back to the neutral position,
the operating unit produces an output signal depending on the shift position of the shiftable actuation device,
the elements on the display device are represented one after the other, in such a manner that a respective front-most element only partially covers subsequent elements, and respective rearward elements are smaller than respective forward elements,
the receiver unit changes the represented elements depending on the output signal of the operating unit depending on the shift position of the actuation device in such a manner that the respective front-most element is replaced by another element, and all additional displayed elements change their size in accordance with their rank order, and
the speed of the change of the elements depends on the shift position of the shiftable actuation device.

2. The multimedia information selection apparatus according to claim 1, wherein the actuation device of the operating unit is shiftable in a straight line in said at least one direction out of the neutral position to the shift position.

3. The multimedia information selection apparatus according to claim 1, wherein the actuation device is shiftable out of the neutral position to a forward shift position for scrolling the displayed elements in a first direction and back to the neutral position to discontinue scrolling, and is shiftable out of the neutral position to a rearward shift position for scrolling the displayed elements in a second direction and back to the neutral position to discontinue scrolling.

4. The multimedia information selection apparatus according to claim 3, wherein the forward shift position and rearward shift position are on the same straight line.

5. The multimedia information selection apparatus of claim 2 wherein the actuation device is shiftable only on the straight line between the shift position and the neutral position.

6. The multimedia information selection apparatus of claim 4 wherein the actuation device is shiftable only on the straight line between the forward and rearward shift positions and through the neutral position.

7. The multimedia information selection apparatus according to claim 1, wherein the actuation device is prestressed by a spring or magnet force in the neutral position, and a shifting of the actuation device against this force occurs when the actuation device is shifted out of neutral position to the shift position.

8. The multimedia information selection apparatus according to claim 1, wherein the receiver device comprises a data storage unit in which the selectable multimedia information is stored.

9. The multimedia information selection apparatus according to claim 1, wherein the operating unit is integrated in the receiver unit or the display device.

10. The multimedia information selection apparatus according to claim 1, wherein the operating unit is a remote control that is separate from the receiver unit and from the display device.

11. The multimedia information selection apparatus according to claim 1, wherein the operating unit comprises a position and/or movement sensor whose output signal controls predetermined functions of the receiver unit and/or of the display device.

12. The multimedia information selection apparatus according to claim 11, wherein the position and/or movement sensor controls static, semi-dynamic or dynamic functions of the receiver unit and/or of the display unit.

13. The multimedia information selection apparatus according to claim 2, wherein the actuation device is prestressed by a spring or magnet force in the neutral position, and a shifting of the actuation device against this force occurs when the actuation device is shifted out of neutral position to the shift position.

14. The multimedia information selection apparatus according to claim 2, wherein the operating unit comprises a position and/or movement sensor whose output signal controls predetermined functions of the receiver unit and/or of the display device.

15. The multimedia information selection apparatus according to claim 14, wherein the position and/or movement sensor controls static, semi-dynamic or dynamic functions of the receiver unit and/or of the display unit.

16. The multimedia information selection apparatus according to claim 4, wherein the operating unit comprises a position and/or movement sensor whose output signal controls predetermined functions of the receiver unit and/or of the display device.

17. The multimedia information selection apparatus according to claim 16, wherein the position and/or movement sensor controls static, semi-dynamic or dynamic functions of the receiver unit and/or of the display unit.
